(19) United States
(12) Patent Application Publication
(10) Pub. No.: US 2013/0074066 A1
(43) Pub. Date: Mar. 21, 2013

(54) Portable Port Profiles for Virtual Machines in a Virtualized Data Center

(71) Applicants: Ajit Sanzgiri, Los Gatos, CA (US); Joseph Swaminathan, Union City, CA (US); Sachin Thakkar, San Jose, CA (US)

(72) Inventors: Ajit Sanzgiri, Los Gatos, CA (US); Joseph Swaminathan, Union City, CA (US); Sachin Thakkar, San Jose, CA (US)

(73) Assignee: CISCO TECHNOLOGY, INC., San Jose, CA (US)

(21) Appl. No.: 13/238,573

(22) Filed: Sep. 21, 2011

(51) Int. Cl. G06F 9/455

(52) U.S. Cl. 718/1

(57) ABSTRACT

Techniques are provided for implementing a portable port profile that is based on a virtual machine (VM) definition file. Properties are specified within the VM definition that allow a virtual switch to look up one or more network policies such as connectivity, firewall, or other enforcement policies, and apply those policies on a customizable basis to the VM's virtual network interface.

### TECHNICAL FIELD

The present disclosure generally relates to port profiles for virtual machines in a virtualized network environment.

### BACKGROUND

Port profiles are used as a configuration template that can be attached to any networking interface for managing traffic across that interface. This template typically consists of interface configuration commands that are entered by a network administrator. The configuration could, for example, describe switch port configuration parameters, access control lists, quality of service policies, private virtual local area network configurations, and the like. Port profiles can be created and then applied to an interface directly through a device management interface by a network administrator managing the network device.

In virtualized environments, port profiles are exported by a virtual switch as port groups to a virtualization manager application (VMA), e.g., VMWare's vCenter. The VMA is designed to work with a vendor specific host and hypervisor combination and can run on any server, whether physical or virtual. A server administrator deploying a Virtual Machine (VM) can then select a port group and attach it to the VM's virtual interface(s) through the VMA. Traffic received from and transmitted to such a virtual interface is then subject to the policies encoded in the port profile by the virtual switch. In this environment, the policy applied to the VM's traffic is selected by the server administrator from a list of port groups provisioned by the network administrator. The port profile mechanism specifies both the policy and network connectivity for an individual virtual network interface.

This conventional port profile mechanism creates two problems in administering the virtualization “cloud” environment. The first problem in a worst case scenario is that the number of port profiles that need to be set up by the network administrator could be as high as the number of policies supported by the product multiplied by the number of supported network connections, if both parameters are independently configurable. Second, in some cases (e.g. when a cloud management application is being used) port profiles are automatically generated based on network connectivity requirements alone. While this arrangement results in the correct connectivity via the interface, it does not allow customization of policies for individual virtual interfaces. For example, if a web server is subject to an access control list specific to web servers, all VMs in the network will be subject to the web server access control list.

### BRIEF DESCRIPTION OF THE DRAWINGS

FIG. 1 is an example of a block diagram of the relevant portions of a network environment featuring a virtual switch that is configured to implement portable port profiles according to the techniques described herein.

FIG. 2 is a first example of a block diagram of a hosting and switching network in a virtualized data center having virtual switches as part of the switches that are configured to implement portable port profiles according to the techniques described herein.

FIG. 3 is a second example of a block diagram of a hosting and switching network having virtual switches as part of the host devices that are configured to implement portable port profiles according to the techniques described herein.

FIG. 4 is an example of a block diagram of a host device that is configured to implement portable port profiles.

FIG. 5A is an example of a flowchart depicting a generally process for implementing portable port profiles.

FIG. 5B is a flowchart depicting a specific example of a process for implementing portable port profiles.

### DESCRIPTION OF EXAMPLE EMBODIMENTS

Overview

Techniques are provided for implementing a portable port profile that is based on a definition file (data) of a virtual machine. Properties are specified within the virtual machine definition that allows a virtual switch to look up one or more network policies such as connectivity, firewall, or other enforcement policies, and apply those policies on a customizable basis to the virtual network interface of the virtual machine. The terms “port group” and “port profile” may be used herein interchangeably to refer to the same concept, namely the policies and connectivity options applied to a virtual machine interface.

The techniques provide for a virtual network device to define and store information representing a plurality of network policies for one or more virtual interfaces. A virtual machine definition is generated comprising information configured to identify one or more of the plurality of properties. Data are stored that associates the virtual machine definition with a virtual machine and the virtual machine is started using the associated virtual machine definition. Information is generated that represents one or more virtual interface port profiles for the virtual machine based on properties identified in the associated virtual machine definition. One or more virtual interfaces are created for the virtual machine and the virtual interface port profiles are applied to the one or more virtual interfaces.

### Example Embodiments

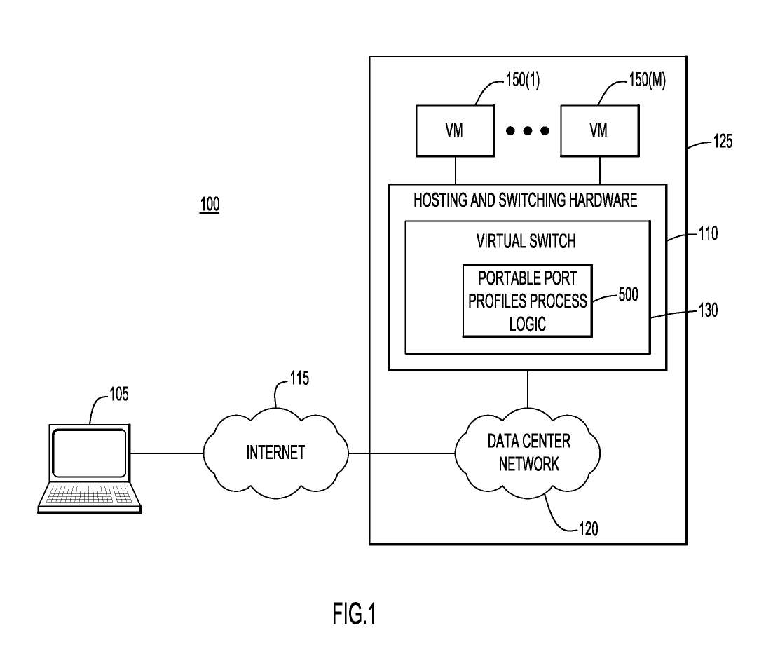

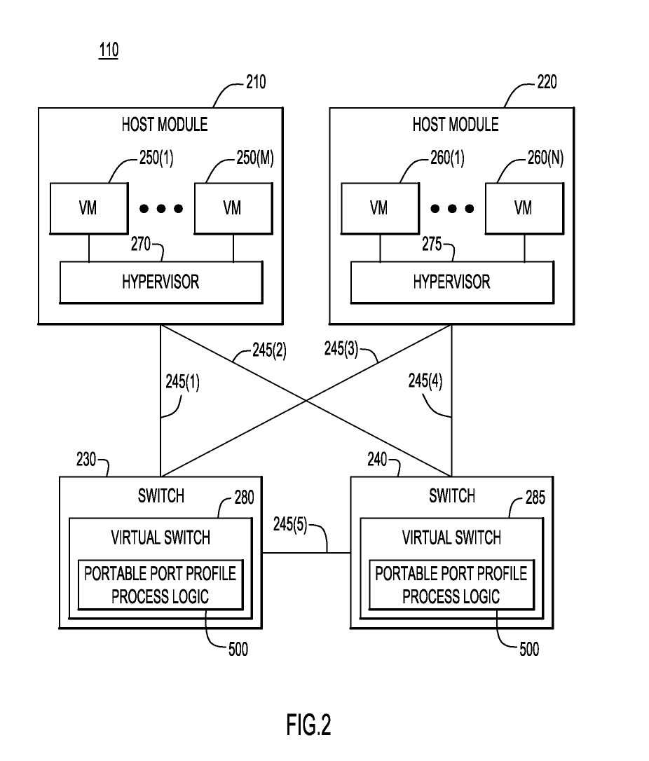

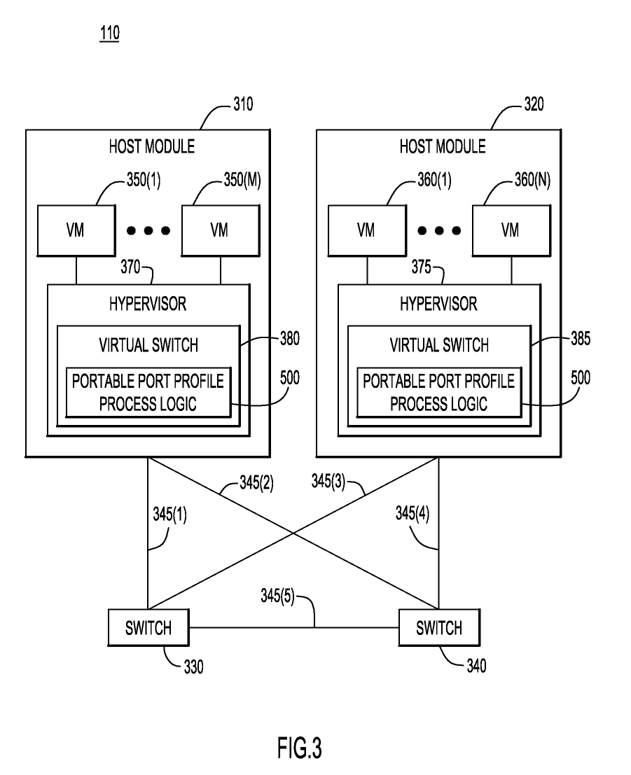

Referring first to FIG. 1, an example of a block diagram of the relevant portions of a network environment 100 is shown with a virtual switch that is configured to implement a portable port profile process 500 according to the techniques described herein. The network 100 has a remote user and interface 105 that communicates to one or more virtual machines 150(1)-150(M) in a data center 125. The user 105 may communicate via the Internet 115 or other network. Traffic to and from user 105 travels by way of a data center network 120, and through hosting and switching hardware 110. Hosting and switching hardware 110 comprises a plurality of hosts, switches, and at least one virtual switch 130 that supports virtual machines 150(1)-150(M). The hosting and switching hardware 110 shown in FIG. 1 is a generic representation of the hardware configuration that may be deployed in the virtualized network environment. Specific implementations of hardware 110 will be described in connection with FIGS. 2 and 3.

VMs have virtual network interface cards (vNICs) that connect to the virtual switch 130 much like physical devices connect to physical switches via physical cables. The vNICs are managed by host devices. Traffic received by the virtual switch 130 from the VMs over the vNICs as well as the traffic transmitted to the VMs by virtual switch 130 complies with policies configured on the vNICs. These policies specify, for instance, the virtual local area network (VLAN) or VLANs for the interface, access control lists (ACLs), Quality of Service (QoS) policies, and a variety of controls for the features supported by the virtual switch 130. A common way to apply a configuration to an interface is for the network administrator to encapsulate policies into port profiles and assign names to these port profiles. The virtual switch software exports these names to a VMA running on a server within data center 125 where they appear as port groups.

When a new virtual machine is deployed, the server administrator selects a port group for each of the VM's vNICs by interacting with the VMA. Hypervisor software instantiates the vNICs and the VMA informs the virtual switch 130 about the vNICs and the port group name associated with each vNIC. Software running on the virtual switch 130 then retrieves the policies stored against each port group name, also referred to as a port profile as mentioned above. The virtual switch 130 applies the policies to the traffic exchanged through the switch. The policies contain both connectivity information such as the VM's virtual local area network (VLAN) as well policy information such as ACLs and QoS parameters.

In some contexts port profiles are applied such that all VMs in the target virtual network get the same port profile. While this results in the correct connectivity or “plumbing” (e.g., the VMs are connected to the same VLAN or virtual network segment) it does not allow individual vNICs in the virtual network to be further customized. Accordingly, it is not possible to customize a port profile for any given vNIC. For example, automatically generated port profiles make it impossible to specify a better QoS, e.g., a QoS profile, for a specific VM or make it impossible to assign a particular ACL to a VM that may better correspond to the VM's function. As another example, if an administrator desires that an Internet Protocol (IP) source guard feature be applied to untrusted VMs, there is still no mechanism to distinguish trusted interfaces from untrusted ones. In other words, the automated nature of port profile assignment results in all the interfaces having to be treated uniformly by the virtual switch in a single, “one-size-fits-all” configuration template set up ahead of time by the network administrator.

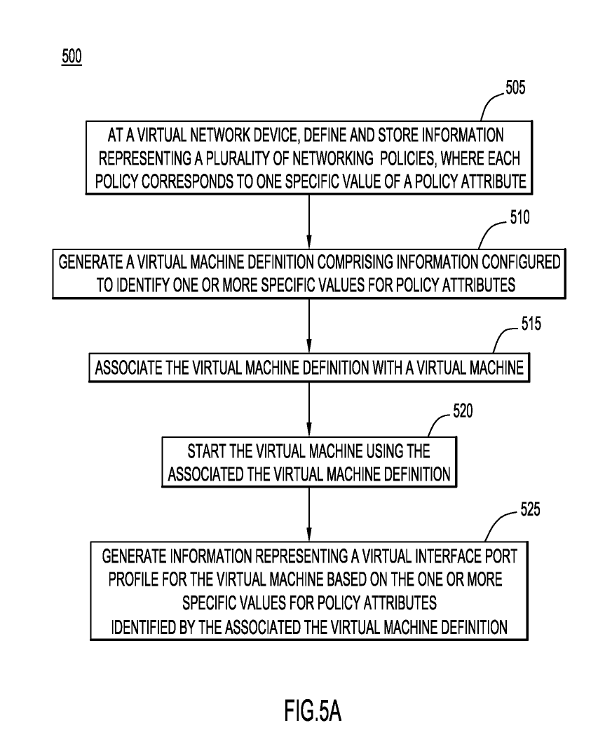

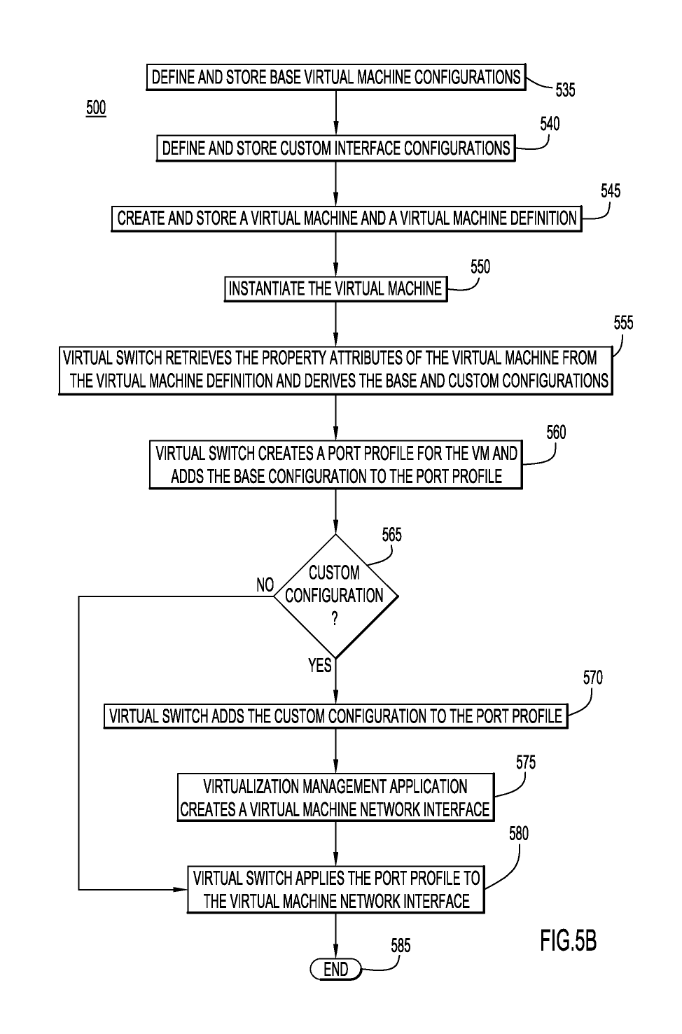

However, the virtual switch 130 shown in FIG. 1 is configured to implement a portable port profile scheme that allows “per vNIC” customization, i.e., by way of portable port profile process logic 500. The techniques described herein provide for a custom, per vNIC configuration that may be derived from attributes that are part of the VM definition itself as described in increasing level of detail hereinafter. Process logic 500 is generally described in connection with FIGS. 2, 3 and 4, and described in greater detail in connection with FIGS. 5A and 5B.

Turning to FIG. 2, a first example configuration for hosting and switching hardware 110 is shown. The hardware 110 comprises host modules or devices 210 and 220, and physical network switches 230 and 240. The hosts 210 and 220, and the switches 230 and 240 are arranged in a commonly used dual-redundant configuration. Failures that occur in one host or switch can be compensated by the other host or switch, respectively. Communications that enable the redundancy are provided by data links 245(1)-245(5). Although only single links are shown, it is to be understood that any number of data links may be provided for inter-hardware connectivity.

The host 210 comprises a hypervisor 270 supporting a plurality of VMs 250(1)-250(M) and host 220 comprises a hypervisor 275 supporting a plurality of VMs 260(1)-260(N). Switches 230 and 240 comprise virtual switches 280 and 285, respectively. Each virtual switch 280 and 285 employs portable port profile process logic 500. Briefly, process logic 500 employs a mechanism to configure VM interfaces (vNICs) using the VM definition. For example, the VM definition file may have an attribute designated as ‘Security profile’. For a VM web server, the value for this attribute within the VM definition file may be ‘WebServer’. Prior configuration on the virtual switch would associate this value with a policy that restricts the network traffic sent to this VM to that appropriate for a web server. Similarly, a VM application server may have the value for the same attribute set to ‘SSH’ and a policy on the virtual switch could associate that value with a policy that only permits SSH traffic. Such policies protect the VMs from attacks launched to exploit vulnerabilities in other protocols and also cause them to waste CPU cycles needlessly. Accordingly, by way of process logic 500, both the VM web server and VM application server may coexist in the same VLAN or network segment while each has a different custom network policy.

The hypervisors 270 and 275 provide operating system independence for the applications running on the VMs for the end users. Any of the VMs are capable of migrating from one physical host (or virtualization hardware) to another physical host in a seamless manner using a process called VM migration, e.g., VM 250(1) may migrate from host module 210 to another host module, e.g., to host module 220, or to another physical host without interruption.

The virtual switches 280 and 285 manage any interfaces needed for the VMs. In one example, the virtual switches 280 and 285 may be a software-based Virtual Ethernet Module (VEM) which runs in conjunction with the hypervisor to provide VM services, e.g., switching operations, Quality of Service (QoS) functions, as well as security and monitoring functions.

Over time, various instances or instantiations of various types of virtual machines will be created, started, stopped, or migrated from one physical server to another based on system conditions, e.g., demand for certain services or various network or processor loads on the switches 230 and 240. When VMs are no longer needed or when they migrate, their resources are returned to their respective hosts or switches, e.g., to switches 230 and 240.

The techniques described herein enable the data center management teams to efficiently manage the data center by applying a network or data center policy to each VM that will follow that VM when it is created or when it migrates. The network policy allows network firewalls to police traffic to and from each VM based on policies indicated in its VM definition, whether or not the traffic physically leaves a switch or not. In other words, traffic exchanged between any two VMs may be policed based on policy regardless of where the VM physically resides.

In addition, non-VM traffic may be supported by the switches and hosts described herein, e.g., configuration communication. For example, the switch 200 may need to support traffic for Internet Small Computer System Interface (iSCSI) communications, Network File System (NFS) operations, Fault Tolerance, VM migration, and other management functions. These additional traffic types may each share or have their own class of service and may operate using their own virtual network interfaces, e.g., by way of a virtual machine kernel interfaces (vmks).

Turning to FIG. 3, a second example configuration for hosting and switching hardware 110 is shown. The hardware 110 comprises host modules or devices 310 and 320, and physical network switches 330 and 340. As in FIG. 2, the hosts 310 and 320, and the switches 330 and 340 are arranged in a commonly used dual-redundant configuration. Communications that enable the redundancy are provided by data links 345(1)-345(5).

The host 310 comprises a hypervisor 370 supporting a plurality of VMs 350(1)-350(M) and host 320 comprises a hypervisor 375 supporting a plurality of VMs 360(1)-360(N). In this example, instead of the switches, the hypervisors 370 and 375 comprise virtual switches 380 and 385, respectively. Each of the virtual switches 380 and 385 employs portable port profile process logic 500. Accordingly, by way of the example architectures, the virtual switch may be implemented in hardware, software, or a combination thereof.

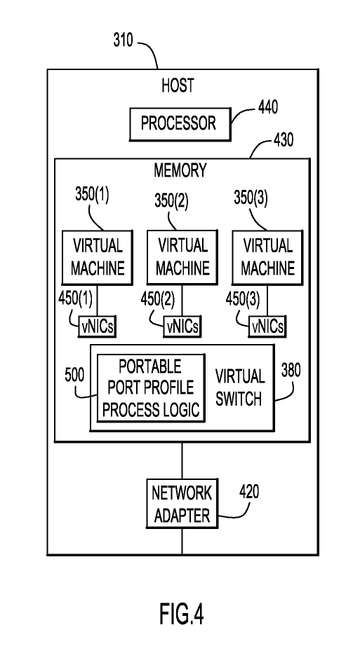

Referring now to FIG. 4, a hardware abstraction of the host 310 from FIG. 3 will now be described. The host 310 includes a network adapter 420, a memory 430, and a processor 440. Resident in memory 430 are a plurality of virtual machines 350(1)-350(3) and a virtual switch 380. The network adapter 420 provides physical connectivity between the host 310 and any external devices that may be coupled to the host 310. The virtual switch 380 provides switching internal and external switching functions for virtual machines 350(1)-350(3). Virtual machines 350(1)-350(3) may provide application, data, and/or host services. The virtual switch 380 is provisioned with portable port profile process logic 500 for enforcing rules for traffic ingressing and egressing virtual machines 350(1)-350(3) according to the techniques described herein. Process logic 500 may also be implemented in hardware or be implemented in a combination of both hardware and software.

The processor 440 is, for example, a microprocessor, a microcontroller, systems on a chip (SOCs), or other fixed or programmable logic. The memory 430 may be any form of random access memory (RAM), read only memory (ROM), FLASH memory, disk storage, or other tangible (non-transitory) memory media (device or devices) that stores data used for the techniques described herein. The memory 430 may be separate or part of the processor 440. One or more computer readable storage media is encoded with software comprising computer executable instructions and when the software is executed operable to perform the operations of the process logic 500. Said another way, instructions for performing the process logic 500 may be stored in the memory 430 for execution by the processor 440 such that when executed by the processor, causes the processor to perform the operations describe herein in connection with the remainder of the figures. Process logic 500 may be stored on other tangible non-transitory (but physically portable or movable) memory such as forms of read only memory ROM, erasable/programmable or not, or other non-volatile memory (NVM), e.g., boot memory for host 310. It should be understood that any of the devices described herein, e.g., switch 200, may be configured with a similar hardware or software configuration as host 310.

The functions of the processor 440 may be implemented by a processor or computer readable tangible (non-transitory) medium encoded with instructions or by logic encoded in one or more tangible media (e.g., embedded logic such as an application specific integrated circuit (ASIC), digital signal processor (DSP) instructions, software that is executed by a processor, etc.), wherein the memory 430 stores data used for the computations or functions described herein (and/or to store software or processor instructions that are executed to carry out the computations or functions described herein). Thus, functions of the process logic 500 may be implemented with fixed logic or programmable logic (e.g., software or computer instructions executed by a processor or field programmable gate array (FPGA)). The process logic 500 executed by a host, e.g., host 310, has been generally described above and will be further described in connection with FIGS. 5A and 5B.

Each VM has one or more corresponding vNICs 450(1)-450(3). For example, each VM may have vNICs for data traffic and a separate vNIC for control traffic. Or it may have multiple vNICs to connect to different networks for receiving and sending different kinds of data traffic. Each VM is started or instantiated by way of a VM definition that may be defined by a data file or other storage means. The VM definition contains information about the VM, e.g., the software image it runs, description of the virtual hardware it emulates and other custom attributes. When a new VM is instantiated, one or more corresponding vNICs are also instantiated.

Process logic 500 allows the virtual switch to customize a vNIC's network policy based on the associated VM's virtual machine definition. When the new VM interface (vNIC) is created, the VM definition contains one or more property attributes each of which references one among many policies. The policies may be stored in a policy database or other storage means. The policy to be applied to the new vNIC may be obtained by way of a database or memory lookup.

Accordingly, when a VM is started (instantiated) or migrates, the vNICs that provide connectivity for the VM are automatically configured with the network policy for that VM by way of the enumerated property attribute values in the VM definition. Put another way, when a user deploys a VM, the VM definition includes a signal that indicates a VM “personality” which can be sensed by the virtual switch to further customize the way traffic is processed to and from a specific VM. This personality can be bound to the VM definition and carried around as a portable port profile. The portable port profile process logic can be further constrained by the network administrator such that the set of such personalities available on a particular virtual network is limited to a predetermined set. By assigning different personalities to different VMs, the problem of customizing VMs on the same network is solved.

Turning to FIG. 5A, an example of a flowchart is shown that depicts a general overview of the operations of the portable port profile process logic 500. At 505, information is defined and stored that represents a plurality of networking policies. Each policy corresponds to one specific value of a policy attribute. The policies may include connectivity policies for VLAN or network segment, VM application specific policies, as well as traffic shaping policies such as ACLs and QoS policies. At 510, a virtual machine definition is generated that comprises information configured to identify one or more specific values for corresponding policy attributes. The information may contain identifiers or Extensible Markup Language (XML) attributes configured to name or point to the policies. In one example, the VM definition is expressed in Open Virtualization Format (OVF) that contains XML code sections that identify the policies or their locations. The XML code may be based on one or more XML namespaces. At 515, the VM definition is associated with the appropriate VM, e.g., data are stored that associates the virtual machine definition with the VM.

At 520, the VM is started using the associated VM definition. A VM instance is created from the VM definition. Before starting the VM, the user, or an application acting on the user's behalf, assigns the vNICs of the newly created VM to portgroups. In this context, the profile or profiles are referred to as a “base configuration” for the vNICs to which it is applied. The base configuration for each vNIC may contain any policies the administrator desires. In addition, the base configuration can list, either directly or indirectly, possible attribute values that correspond to each policy to be enforced in the case the corresponding vNIC is found to have an attribute with that value. These policies represent a further customization of the aggregate policy in addition to the base configuration and are referred to herein as “custom” configurations. Once the VM is started the attributes associated with it may be ‘read’ by the virtual switch in one of several ways, e.g., by querying the VMA. At 525, the virtual switch retrieves the base configuration in the port profile associated with each vNIC. It also retrieves vNIC specific attributes from the VM. If the base configuration has further custom policies depending on attributes those custom configurations are added to the aggregate policy to be enforced on the vNIC.

To further illustrate the details of the portable port profile process logic 500 reference is made to the flow chart shown in FIG. 5B. At 535, base virtual machine policy configurations are defined and stored. A base VM policy configuration can specify configurations common to all VMs that share the port profile. At 540, custom virtual machine policy configurations are defined and stored. The custom VM policy configurations allow further customization of the VM interface. For example, a network administrator may want to apply a different QoS and ACL policies to one web server and a different QoS and ACL policies to another web server within the same subnet. The custom policy configurations allow the administrator to customize the individual web server interfaces while maintaining the base web server configuration. The custom policy configuration may be used with or without a base policy configuration, i.e., the base and custom policies are not bound together.

Policies are generally stored in a database maintained by the VSM application. The database is held in runtime memory by the VSM and also saved in some form of persistent storage. If the VSM runs in a virtual machine itself, this persistent storage may be a local hard disk in the server on which that virtual machine runs or in some network accessible storage to which the server has access. The VSM can also run in a dedicated hardware appliance, in which case it uses the storage within that appliance. VM definitions are also stored in persistent storage which could be local to the server on which the VMA runs or a network attached storage volume.

The base configuration and custom policy configurations may be considered to be configuration templates for each of a set of virtual interfaces and may be provided to administrators in the form of a list, e.g., a windows drop list or pull-down menu, or a non-windows type listing. They may be defined by way of a command line interface (CLI). The selection of one configuration template from among the list is made based on a property signaled by the VM and dynamically sensed by the virtual switch. Different VMs in the same network can signal different values for their template properties or attributes, and provide per-VM customization as described above.

At 545, a VM is created along with its VM definition. Typically, VMs such as web servers or word processing applications are created by a software development team that generates an executable or disk image that can be exported into a virtualized environment. Once in the virtualized environment the disk image can be used to instantiate a particular VM. The VM definition contains information that allows the virtual switch to determine which custom configurations to apply to the VM's interfaces (vNICs). At 550, the VM is instantiated or otherwise started or executed as in a software program. The process 500 functions at 535, 540, and 545 are preliminary elements that are performed ahead of time before the VM is started. The functions may be executed by way of human interaction with the switch, supervisor module, or management platform. The preliminary elements may also be executed by a script or batch file.

At 555, the virtual switch retrieves the property attributes of the VM from the VM definition and derives the base and custom configurations for the VM's vNICs by combining those property attributes with the base configuration. Once retrieved, at 560, the virtual switch creates a port profile for the VM and adds the base configuration to the port profile. At 565, the virtual switch checks to see if there is any custom configuration information corresponding to the VM attributes and that the custom configuration is contained in the policy database. If a custom configuration is not available, processing proceeds to 580. If custom configuration information is available, the process continues at 570. If either the VM definition or the policy database does not concur for the requisite configuration and/or information, an error is returned to the appropriate monitoring entity.

At 570, the virtual switch adds the custom policy configuration to the port profile. At 575, a management application, e.g., a VMA, creates the VM network interface. Another example is an attribute called ‘QoS Profile’ that has values which map to different QoS policies. The order is always the same: the VM is powered on, vNICs are created, the virtual switch discovers attributes, translates them into a port profile and applies the port profile to the vNIC(s) in question.

At 580, the virtual switch applies the port profile, i.e., the policies embedded therein, to the VM's network interface. At 585, the process ends. At this point, the VM's traffic is regulated according to the policies of its vNIC(s).

The base and custom VM policy configurations are bound to a corresponding virtual interface rather than to the VM, which can send and receive traffic by way of multiple virtual interfaces. The properties, attributes, various configuration pointers, selectors, e.g., personalities as described above, can be set dynamically by an administrator for one or more operational VMs using a management interface, i.e., they may be set interactively. The process of specifying attributes may be facilitated by an application embedded within the VM. The properties or attributes may be part of the VM's static definition (along with its virtual disk image) and come pre-provisioned out of a virtual application catalog. In other examples, some virtualization environments allow application interfaces (APIs) for third party applications, the properties could be set by a monitoring application based on the observed behavior of the VM.

The virtualization environment described herein is one example of such an environment. In other virtual environments, the definition and setting of such properties may depend on the virtualization environment infrastructure and the components therein. The above portable port profile techniques are readily adapted to the other virtualization environments.

The techniques described herein provide a unique way to bind a configuration template to an interface. The various mechanism available allow different types of users (e.g., server administrators, application providers, service provider customers, etc.) a choice of what kind of policy to request by adding the appropriate attributes to the VM definition, within constraints set by the service provider, and without the need to access the switch's management interface or depend upon a specific management application.

To summarize, the network administrator defines a set of service policies, say one for a web server, one for a database server, and one for a virtual router. The web server policy may specify an ACL that denies all traffic except what a web server needs (HTTP, ARP, SSH). The database server policy could specify a higher quality of service and the virtual router policy could specify a trustworthiness attribute that allows the switch to allow the virtual router to respond to DHCP requests. Other DHCP responses would be disallowed to all other VMs, thus preventing a potential rogue VM from contaminating the DHCP database. The network administrator configures the switch to activate the web server policy for any VM advertising itself as a web server, activate the database server policy for any VM advertising itself as a database server, and activate the virtual router policy on any device recognized as a virtual router. When the server administrator deploys VMs within the virtual network he/she would make sure appropriate VMs are set up with the corresponding properties.

The techniques provide for a virtual network device to define and store information representing a plurality of properties for one or more virtual interfaces. As used herein, the term “properties” may refer to a VM interface property, a network policy, a pointer to a network policy, or an enumerated value for a network policy, e.g., port 22 for SSH traffic, or any other information that allows the virtual switch and/or VMA to create a custom policy. A virtual machine definition is generated comprising information configured to identify one or more of the plurality of properties. Data are stored that associates the virtual machine definition with a virtual machine and the virtual machine is started using the associated the virtual machine definition. Information is generated that represents a virtual interface port profile for the virtual machine based on properties identified by the associated the virtual machine definition. One or more virtual interfaces are created for the virtual machine and the virtual interface port profile is applied to the one or more virtual interfaces.

Further techniques are provided that define a base configuration for virtual machines that perform a common function and that define a custom configuration for a virtual machine specific network policy. The virtual machine stores the information that identifies the plurality of properties. These properties are retrieved by a virtual switch hosted on the virtual network device. The virtual switch generates the information representing the virtual interface port profile identified based on the information retrieved from the virtual machine. The information may be stored using a markup language, e.g., XML or OVF.

The virtual machine may be migrated from a first virtualized network environment to a second virtualized network environment and a new port profile is generated for the virtual machine in the second virtualized network environment based on the virtual machine's virtual machine definition.

The portable port profile techniques described herein offer advantages with respect to previously techniques. For example, the portable port profile keeps control of the network with network service provider. It also provides a flexible mechanism to users to select from a set of policies, and lends itself to cloning VMs and cataloging of virtual applications. The portable profile also facilitates a separation of roles between service consumers and service providers.

The above description is intended by way of example only.

What is claimed is:

1. A method comprising:
at a virtual network device, defining and storing information representing a plurality of properties for one or more virtual interfaces;
generating a virtual machine definition comprising information configured to identify one or more of the plurality of properties;
storing data that associates the virtual machine definition with a virtual machine;
starting the virtual machine using the associated virtual machine definition;
generating information representing one or more virtual interface port profiles for the virtual machine based on properties identified by the associated virtual machine definition.

2. The method of claim 1, further comprising:
creating one or more virtual interfaces for the virtual machine; and
applying the virtual interface port profile to the one or more virtual interfaces.

3. The method of claim 1, wherein defining comprises defining a base configuration for virtual machines that perform a common function.

4. The method of claim 1, wherein defining comprises defining a custom configuration for a virtual machine specific network policy.

5. The method of claim 1, further comprising:
retrieving from the virtual machine the information from the port profile of the virtual machine configured to identify the plurality of properties to a virtual switch hosted on the virtual network device; and
wherein generating information comprises generating by the virtual switch the information representing the virtual interface port profile identified based on the information retrieved from the virtual machine.

6. The method of claim 5, wherein retrieving comprises retrieving the information using a markup language.

7. The method of claim 6, wherein the markup language comprises one of Extensible Markup Language and Open Virtualization Format.

8. The method of claim 1, further comprising:
migrating the virtual machine from a first virtualized network environment to a second virtualized network environment; and
generating a new port profile in the second virtualized network environment for the virtual machine based on the virtual machine definition.

9. An apparatus comprising:
a network adaptor configured to enable communication with a data center network; and
a processor configured to:
define and store information representing a plurality of properties for one or more virtual interfaces;
generate a virtual machine definition comprising information configured to identify one or more of the plurality of properties;
store data that associates the virtual machine definition with a virtual machine;
start the virtual machine using the associated the virtual machine definition; and
generate information representing a virtual interface port profile for the virtual machine based on properties identified by the associated the virtual machine definition.

10. The apparatus of claim 9, wherein the processor is further configured to:
create one or more virtual interfaces for the virtual machine; and
apply the virtual interface port profile to the one or more virtual interfaces.

11. The apparatus of claim 9, wherein the processor is configured to define and store a base configuration for virtual machines that perform a common function.

12. The apparatus of claim 9, wherein the processor is configured to define and store a custom configuration for a virtual machine specific network policy.

13. The apparatus of claim 9, wherein the processor is further configured to:
host a virtual switch;
retrieve from the virtual machine the information from the port profile of the virtual machine configured to identify the plurality of properties to the virtual switch; and
generate by way of the virtual switch the information representing the virtual interface port profile identified based on the information retrieved from the virtual machine.

14. The apparatus of claim 13, wherein the processor is configured to retrieve the information using a markup language.

15. The apparatus of claim 14, wherein the processor is configured to send the information using a markup language comprising one of Extensible Markup Language and Open Virtualization Format.

16. The apparatus of claim 9, wherein the processor is further configured to:
detect a new virtual machine that has migrated from another virtualized network environment to a virtualized network environment managed by the processor; and
generate a port profile for the new virtual machine based on a virtual machine definition for the new virtual machine.

17. One or more computer readable storage media storing instructions that, when executed by a processor, cause the processor to:
define and store information representing a plurality of properties for one or more virtual interfaces;
generate a virtual machine definition comprising information configured to identify one or more of the plurality of properties;
store data that associates the virtual machine definition with a virtual machine;
start the virtual machine using the associated the virtual machine definition; and
generate information representing a virtual interface port profile for the virtual machine based on properties identified by the associated the virtual machine definition.

18. The computer readable storage media of claim 17, further comprising instructions that, when executed by the processor, cause the processor to:
create one or more virtual interfaces for the virtual machine; and
apply the virtual interface port profile to the one or more virtual interfaces.

19. The computer readable storage media of claim 17, wherein the instructions operable to define and store comprise instructions operable to define and store a base configuration for virtual machines that perform a common function.

20. The computer readable storage media of claim 17, wherein the instructions operable to define and store comprise instructions operable to define and store a custom configuration for a virtual machine specific network policy.

21. The computer readable storage media of claim 17, further comprising instructions that, when executed by the processor, cause the processor to:
host a virtual switch;
retrieve from the virtual machine the information from the port profile of the virtual machine configured to identify the plurality of properties to the virtual switch; and
generate by way of the virtual switch the information representing the virtual interface port profile identified based on the information retrieved from the virtual machine.

22. The computer readable storage media of claim 21, wherein the instructions operable to send comprises instructions operable to retrieve the information using a markup language.

23. The computer readable storage media of claim 22, wherein the instructions operable to send comprises instructions operable to send the information using a markup language comprising one of Extensible Markup Language and Open Virtualization Format.

24. The computer readable storage media of claim 19, further comprising instructions that, when executed by the processor, cause the processor to:
detect a new virtual machine that has migrated from another virtualized network environment to a virtualized network environment managed by the processor; and
generate a port profile for the new virtual machine based on a virtual machine definition for the new virtual machine.
